(19) United States
(12) Patent Application Publication
(10) Pub. No.: US 2015/0072235 A1
(43) Pub. Date: Mar. 12, 2015

(54) POWDER MANUFACTURING APPARATUS AND ANODE ACTIVE MATERIAL FOR SECONDARY BATTERY MANUFACTURED BY THE APPARATUS

(71) Applicant: MK ELECTRON CO., LTD., Gyeonggi-do (KR)

(72) Inventors: Soon Ho HONG, Yongin-si (KR); Jong Soo CHO, Seoul (KR); Hyung Ki AHN, Suwon-si (KR)

(73) Assignee: MK ELECTRON CO., LTD., Gyeonggi-do (KR)

(21) Appl. No.: 14/143,277

(22) Filed: Dec. 30, 2013

(30) Foreign Application Priority Data
Sep. 11, 2013 (KR) 10-2013-0109211

(51) Int. Cl. H01M 4/134; C23C 4/10; B02C 23/00; C23C 4/12

(52) U.S. Cl. CPC H01M 4/134; C23C 4/121; C23C 4/105; B02C 23/00
USPC 429/218.1; 239/82; 241/101.4

(57) ABSTRACT

Provided is an apparatus for manufacturing a powder alloy used as an anode active material of a secondary battery. The apparatus includes a nozzle unit for melting and spraying an alloy, a cooling unit for cooling down the alloy sprayed from the nozzle unit, a grinding unit for grinding the alloy cooled by the cooling unit, and a first chamber accommodating the nozzle unit, the cooling unit, and the grinding unit, and maintained to be a vacuum state.

### RELATED APPLICATIONS

This application claims the benefit of Korean Patent Application No. 10-2013-0109211, filed on Sep. 11, 2013, in the Korean Intellectual Property Office, the disclosure of which is incorporated herein in its entirety by reference.

### BACKGROUND

1. Field

One or more embodiments of the present invention relate to a powder manufacturing apparatus and anode active material for secondary battery manufactured by the apparatus, and more particularly, to a powder manufacturing apparatus that can effectively adjust a particle-size distribution of the powder alloy and to an anode active material having an excellent lifespan characteristic.

2. Description of the Related Art

Recently, lithium secondary batteries have been used as power source of portable electronic products such as mobile phones, laptop computers, and the like, and also used as medium and large sized power source of hybrid electric vehicles (HEVs) and plug-in HEVs. Owing to expansion of applied fields and increase in demands, external shapes and sizes of the lithium secondary batteries are being modified variously, and superior capacity, lifespan, and safety to those of small-sized batteries are necessary.

A lithium secondary battery is manufactured by using materials which lithium ions can be intercalated into and deintercalated from, as an anode and a cathode, and is manufactured generally by forming a porous separation film between the anode and the cathode and injecting an electrolyte. In addition, electric current is produced or consumed by a redox reaction caused by intercalation/deintercalation of lithium ions in the anode and the cathode.

Graphite is widely used in conventional lithium secondary batteries as an anode active material, and has a layered structure which lithium ions can be easily intercalated into and deintercalated from. Graphite has a theoretical capacity of 372 mAh/g; however, demands for lithium batteries of high capacity have been increased recently, a new electrode that may substitute for the graphite has been required. Thus, research has been actively conducted on commercialization of an electrode active material that may form electrochemical alloy with lithium ions, such as silicon (Si), tin (Sn), antimony (Sb), and aluminum (Al), as a high-capacity anode active material. However, when silicon (Si), tin (Sn), antimony (Sb), aluminum (Al), or the like are electrochemically plated with lithium, the volume of the resultant structure increases or decreases during a charge/discharge process. Such a volume change deteriorates cycle characteristics of an electrode employing silicon (Si), tin (Sn), antimony (Sb), aluminum (Al), or the like as an anode active material. Also, such a volume change causes cracks in a surface of the electrode active material. When cracks occur repeatedly in the surface of the electrode active material, fine particles may be formed in the surface of the electrode, thereby deteriorating cyclic characteristics.

An anode active material having a fine structure, in which fine particles of Si or Sn are evenly dispersed in a matrix, has been developed in order to prevent the electrode active material from being damaged due to the variation in the volume. In general, examples of powder alloy manufacturing methods are an atomization method, a melt-spinning method, a rotating electrode method, a mechanical grinding method, etc. In order to manufacture a silicon-metal powder alloy or a tin-metal powder alloy that is used as an anode active material of a secondary battery, it is necessary to evenly disperse fine particles in a matrix, and thus, the powder alloy needs to be formed by using a rapid solidification method and a particle-size distribution of the powder alloy needs to be adjusted efficiently.

### SUMMARY

One or more embodiments of the present invention include an apparatus for manufacturing powder capable of manufacturing a silicon-metal powder alloy adjusting a particle-size distribution of a powder alloy effectively and having excellent lifespan characteristic.

One or more embodiments of the present invention include an anode active material including a silicon-metal powder alloy manufactured by the apparatus for manufacturing powder.

Additional aspects will be set forth in part in the description which follows and, in part, will be apparent from the description, or may be learned by practice of the presented embodiments.

According to one or more embodiments of the present invention, an apparatus for manufacturing a powder alloy used as an anode active material of a secondary battery, the apparatus includes: a nozzle unit for melting and spraying an alloy; a cooling unit for cooling down the alloy sprayed from the nozzle unit; a grinding unit for grinding the alloy cooled by the cooling unit; and a first chamber accommodating the nozzle unit, the cooling unit, and the grinding unit, and maintained to be a vacuum state.

The nozzle unit may include: an accommodation unit for accommodating the alloy; a heating unit for melting the alloy; and a nozzle hole for spraying the alloy.

The accommodation unit may be formed of one of graphite, Al₂O₃, ZrO₂, and a boron nitride (BN).

The cooling unit may be formed as a roll, and may rapidly cool the alloy sprayed from the nozzle unit while rotating in order to form a rapidly solidified strip.

The rapidly solidified strip may be continuously extended to the grinding unit within the first chamber.

The grinding unit may include a roll, and may further cool the alloy that is cooled by the cooling unit and grinds the alloy while rotating the roll.

The grinding unit may include one or more disk plates.

A rotary shaft of the grinding unit may be perpendicular to a rotary shaft of the cooling unit.

The grinding unit may include: a first grinding unit for firstly cooling and grinding the alloy cooled by the cooling unit; and a second grinding unit for secondly cooling and grinding the alloy ground by the first grinding unit.

The apparatus may further include: a dissolution unit for melting the alloy; and a second chamber accommodating the dissolution unit and maintained to be a vacuum state, wherein the alloy melted in the dissolution unit is moved into the nozzle unit.

The dissolution unit may include: a dissolving crucible for accommodating the alloy; and a heating unit for melting the alloy.

According to one or more embodiments of the present invention, an anode active material for a secondary battery, the anode active material includes a powder alloy manufactured by the apparatus for manufacturing a powder alloy, which is described above, wherein the powder alloy includes silicon single phases, each having a grain size of about 100 nm or less, are evenly distributed in a matrix of a silicon-metal alloy.

In a particle-size distribution of the powder alloy, when a powder diameter at a point where the number of powder particles accumulated from the smallest one corresponds to 10% of the number of entire particles is defined as D0.1, and a powder diameter at a point where the number of powder particles accumulated from the smallest one corresponds to 90% of the number of entire particles is defined as D0.9, a value of D0.1 of the powder alloy may be 1 μm or greater and a value of D0.9 may be 1000 μm or less.

The powder alloy may be included in the anode active material in a state of alloy fine powders ground finely by a ball milling process, and in a particle-size distribution of the powder alloy, when a powder diameter at a point where the number of powder particles accumulated from the smallest one corresponds to 10% of the number of entire particles is defined as D0.1, and a powder diameter at a point where the number of powder particles accumulated from the smallest one corresponds to 90% of the number of entire particles is defined as D0.9, a value of D0.1 of the alloy fine powder may be 0.1 μm or greater and a value of D0.9 may be 100 μm or less.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram of an apparatus for manufacturing powder, according to an embodiment of the present invention;

FIG. 2 is a schematic diagram of an apparatus for manufacturing powder according to another embodiment of the present invention;

FIG. 3 is a schematic diagram of an apparatus for manufacturing powder according to another embodiment of the present invention;

FIG. 4 is a schematic diagram of a secondary battery according to an embodiment of the present invention;

FIGS. 5A and 5B are schematic diagrams of an anode and a cathode according to an embodiment of the present invention;

FIG. 6 is a flowchart illustrating a method of manufacturing an anode according to an embodiment of the present invention;

FIGS. 7A through 7C are graphs of particle-size distributions of a silicon-metal powder alloy according to an embodiment of the present invention;

FIGS. 8A through 8C are graphs of particle-size distributions of a silicon-metal alloy fine powder according to an embodiment of the present invention;

FIG. 9 is an image of a fine structure of a rapidly solidified strip, according to a comparative example of the present invention;

FIGS. 10 and 11 are images of a fine structure of a silicon-metal powder alloy, according to embodiments of the present invention;

FIG. 12 is graphs showing X-ray diffraction patterns of the alloy fine powder, according to embodiments of the present invention; and

FIGS. 13 and 14 are graphs illustrating lifespan characteristics of an anode, according to embodiments of the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

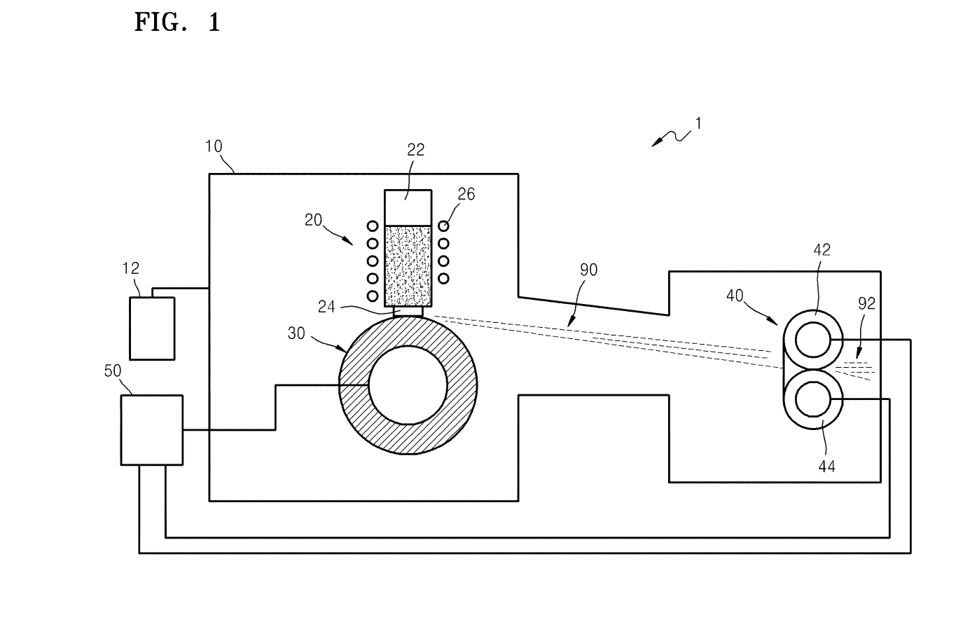

FIG. 1 is a schematic diagram of an apparatus for manufacturing powder 1 according to an embodiment of the present invention.

Referring to FIG. 1, a powder manufacturing apparatus 1 includes a vacuum chamber 10, a nozzle unit 20, a cooling unit 30, and a grinding unit 40.

The vacuum chamber 10 accommodates the nozzle unit 20, the cooling unit 30, and the grinding unit 40 therein, and an inside of the vacuum chamber 10 is maintained at a vacuum state. The vacuum chamber 10 prevents a powder alloy ribbon and powder alloy particles, which are rapidly solidified in the cooling unit 30, from contacting the external air, so as to avoid oxidization of the powder alloy ribbon and the powder alloy particles. An operating pressure in the inside of the vacuum chamber 10 may be less than or equal to 1×10⁻⁵ Mpa. The vacuum chamber 10 may be connected to a vacuum pump 12 in order to maintain the vacuum pressure in the vacuum chamber 10.

The nozzle unit 20 may include an accommodation unit 22, a nozzle hole 24, and a heating unit 26.

The accommodation unit 22 may accommodate an alloy therein, and may have a single-layered structure or a stacked structure of a plurality of layers of a ceramic material such as graphite, an aluminum oxide (Al₂O₃), a zirconium oxide (ZrO₂), or a boron nitride (BN). For example, the accommodation unit 22 may be formed of a material having a low reactivity and a high thermal resistance. If there is a possibility of generating an undesired reaction due to a contact between the material forming the accommodation unit 22 and the alloy accommodated in the accommodation unit 22, a coating layer (not shown) covering an inner wall of the accommodation unit 22 may be further formed of a material that is not reactive with the alloy.

The heating unit 26 may be a heating unit for melting the alloy in the accommodation unit 22, for example, an induction coil. In FIG. 1, the heating unit 26 is formed to surround an outer wall of the accommodation unit 22 as the induction coil; however, the embodiments of the present invention are not limited thereto, that is, any kind of heating unit may be used provided that it may heat the accommodation unit 22. For example, the heating unit 26 may be formed integrally with the accommodation unit 22 while surrounding the outer wall of the accommodation unit 22.

The nozzle hole 24 is formed on a lower end of the accommodation unit 22, and the alloy melted in the accommodation unit 22 may be sprayed out of the accommodation unit 22 via the nozzle hole 24. There may be a plurality of nozzle holes 24. In addition, a spraying pressure providing unit (not shown) may be further formed to provide a spraying pressure to spray the melted alloy in the accommodation unit 22 via the nozzle hole 24. For example, an inert gas of a high pressure may be supplied from the spraying pressure providing unit so as to easily spray the melted alloy via the nozzle hole 24, and in this case, an inert gas such as argon or nitrogen may be used.

The cooling unit 30 may cool down the melted alloy sprayed through the nozzle hole 24. The cooling unit 30 may be formed as a roll that is connected to a cooling tank 50 so that a temperature of the roll may not rise. The roll of the cooling unit 30 may be formed of metal having a high thermal shock resistance and a high thermal conductivity such as copper (Cu), chrome (Cr), or iron (Fe). The melted alloy sprayed from the nozzle hole 24 is rapidly cooled down on contacting the roll of the cooling unit 30, and thus, a rapidly solidified strip 90 may be formed. The melted alloy may be cooled down rapidly, for example, a cooling speed may range from 10³ to 10⁷° C./sec. The cooling speed may vary depending on a rotating speed, a material, and a temperature of the roll.

The rapidly solidified strip 90 may be formed as a ribbon or a flake. A length and/or a thickness of the rapidly solidified strip 90 may vary depending on a size of the nozzle hole 24, a rotating speed of the roll of the cooling unit 30, and a temperature of the roll. For example, the roll may rotate at a speed ranging from about 1000 to about 5000 revolutions per minute (rpm) by a rotating unit (not shown) such as a motor. Also, the length and/or the thickness of the rapidly solidified strip 90 may vary depending on a distance between the cooling unit 30 and the nozzle hole 24. For example, if the nozzle hole 24 and the cooling unit 30 are too close to each other, some of the sprayed melted alloy is cooled down around the nozzle hole 24, and thereby reducing a diameter of the nozzle hole 24 or blocking an inlet of the nozzle hole 24. If the nozzle hole 24 and the cooling unit 30 are too far from each other, a time for the melted alloy sprayed from the nozzle hole 24 to reach the roll of the cooling unit 30 is increased, and the cooling speed of the melted alloy may be reduced. Accordingly, silicon particles precipitated in a matrix may be coalesced, and thus, a rapid solidification effect may be degraded.

The grinding unit 40 may grind the rapidly solidified strip 90 cooled by the cooling unit 30 to form a power alloy 92. In one or more embodiments of the present invention, the grinding unit 40 may be located so that the rapidly solidified strip 90 generated by the cooling unit 30 glides directly to the grinding unit 40 in the vacuum chamber 10. Therefore, the rapidly solidified strip 90 may be continuously extended toward the grinding unit 40 in the vacuum chamber 10. Although not shown in FIG. 1, a guide (not shown) may be formed between the grinding unit 40 and the cooling unit 30 so that the rapidly solidified strip 90 generated by the cooling unit 30 may be easily located on the grinding unit 40.

According to the present embodiment, the grinding unit 40 may include two grinding rollers 42 and 44. The grinding rollers 42 and 44 that are adjacent to each other rotate in different directions from each other to ground the rapidly solidified strip 90 introduced into a space between the grinding rollers 42 and 44 to generate the powder alloy 92. For example, the grinding rollers 42 and 44 may rotate at a speed ranging from about 1000 to about 3000 rpm by a rotating unit (not shown) such as a motor.

According to the present embodiment, the grinding rollers 42 and 44 may include a disk plate that is rotated. In FIG. 1, the two grinding rollers 42 and 44 are included in the grinding unit 40; however, only one grinding roller may be included in the grinding unit 40. Also, the grinding rollers 42 and 44 are formed as disks; however, one or more embodiments of the present invention are not limited thereto. In addition, a rotary shaft of the grinding unit 40 may be disposed perpendicularly to a rotating shaft of the cooling unit 30; however, relative locations of the grinding unit 40 and the cooling unit 30 are not limited thereto.

Selectively, the grinding rollers 42 and 44 may be connected to a cooling tank 50. In this case, the rapidly solidified strip 90 may be additionally cooled down while being ground to fine powder. In general, the melted silicon-metal alloy sprayed from the nozzle hole 24 is instantly solidified on contacting the roll of the cooling unit 30 to form the rapidly solidified strip 90 of a ribbon shape, and thus, the rapid solidification may be performed effectively when a contact area between the melted alloy and the roll of the cooling unit 30 is increased. If a size (thickness or length) of the rapidly solidified strip 90 is too large, a ratio of an area contacting the roll with respect to the entire area of the rapidly solidified strip 90 may be reduced, and accordingly, a temperature difference between a surface and an inside of the rapidly solidified strip 90, or a temperature difference between a lower surface (i.e., a surface contacting the roll) and an upper surface (i.e., a surface opposite to the surface contacting the roll) of the rapidly solidified strip 90 may be generated. That is, a temperature of the lower surface of the rapidly solidified strip 90, which directly contacts the cooling unit 30, may be lower than that of inside the rapidly solidified strip 90. Therefore, the lower surface of the rapidly solidified strip 90 may have a fine structure, in which silicon single phase particles of fine sizes, for example, a diameter of a few nm to tens of nm, are evenly distributed in a silicon-metal alloy matrix, due to the rapid cooling operation. On the other hand, the inside or the upper surface of the rapidly solidified strip 90 may not be rapidly cooled down, and thus, the silicon single phase particles grows (grain growth) and may be coalesced. However, according to the present embodiment, the grinding unit 40 is formed to be adjacent to the cooling unit 30, and the grinding unit 40 is connected to the cooling tank 50 to be maintained at a low temperature. Therefore, the rapidly solidified strip 90 may be ground to the power alloy 92 of smaller size in the grinding unit 40, and the powder alloy 92 is additionally cooled down. Therefore, the powder alloy 92 may have a fine structure, in which the silicon single phase particles of fine and uniform sizes are distributed in the silicon-alloy matrix.

Also, the grinding unit 40 is located in the vacuum chamber 10 in which the cooling unit 30 is also located, and thus, oxidation of the surface of the rapidly solidified strip 90 due to the air may be prevented during the grinding process of the rapidly solidified strip 90 into the powder alloy 92.

According to the present embodiment, the powder alloy 92 may have a diameter of about 1 to 1000 μm. The diameter of the powder alloy 92 may vary depending on the rotating speed of the grinding rollers 42 and 44 of the grinding unit 40.

According to the powder manufacturing apparatus 1 of the present embodiment, the silicon-metal powder alloy capable of adjusting the particle-size distribution effectively and having excellent lifespan characteristic may be manufactured.

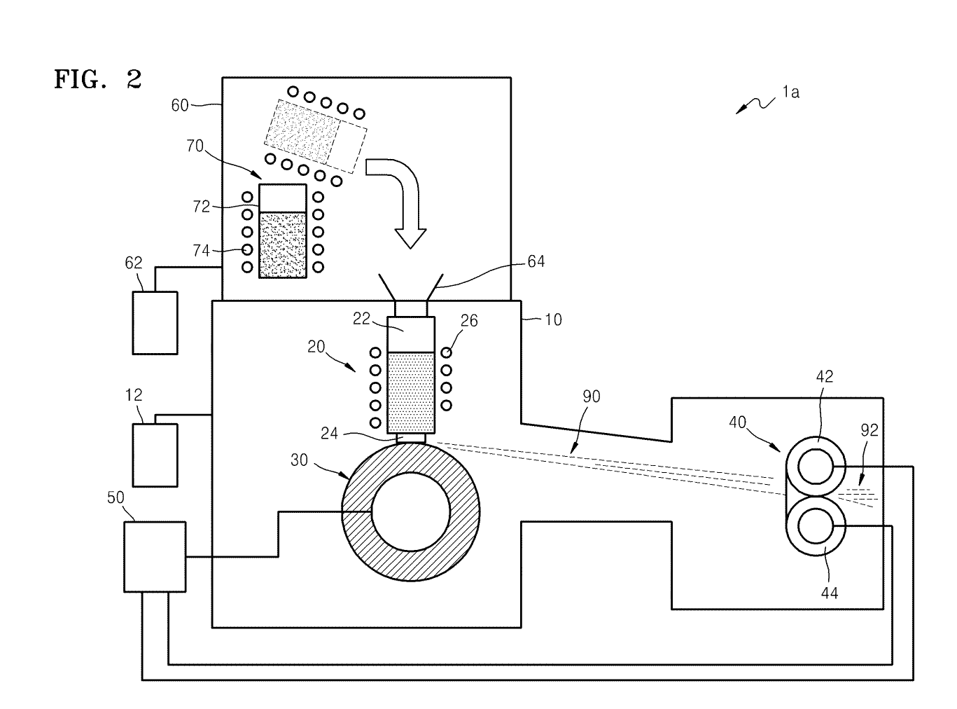

FIG. 2 is a schematic diagram of a powder manufacturing apparatus 1a according to another embodiment of the present invention. The powder manufacturing apparatus 1a shown in FIG. 2 is the same as the powder manufacturing apparatus 1 shown in FIG. 1, except for further including a dissolution unit 70 and a dissolving chamber 60.

Referring to FIG. 2, the powder manufacturing apparatus 1a may further include a dissolving chamber 60 connected to an upper portion of the vacuum chamber 10. The dissolving chamber 60 may be connected to a vacuum pump 62 to maintain an inside thereof at a vacuum state.

The dissolution unit 70 may include a dissolving crucible 72 and a heating unit 74, and accommodates an alloy in the dissolution unit 70 to melt the alloy. The dissolution unit 70 is located in the dissolving chamber 60, and maintained at a vacuum state to prevent an oxidation of melted alloy due to the air during melting the alloy.

The dissolving crucible 72 may receive the alloy therein, and may be formed to have a single-layered structure or a stacked structure of a plurality of layers formed of a ceramic material such as graphite, an aluminum oxide (Al₂O₃), a boron nitride (BN), and the like. For example, a material for forming the dissolving crucible 72 may be a structurally and chemically stabilized material at a temperature higher than a melting temperature of the alloy. If there is a possibility of generating an undesired reaction between the material forming the dissolving crucible 72 and the alloy received in the dissolving crucible 72, a coating layer (not shown) covering an inner wall of the dissolving crucible 72 may be further formed of a material that is not reactive with the alloy.

The heating unit 74 may be a unit for melting the alloy in the dissolving crucible 72, for example, an induction coil. In FIG. 2, the heating unit 74 is formed as an induction coil that surrounds an outer wall of the dissolving crucible 72; however, the embodiments of the present invention are not limited thereto, that is, any kind of heating unit may be used provided that the dissolving crucible 72 may be heated. For example, the heating unit 74 may be formed integrally with the dissolving crucible 72 while surrounding the outer wall of the dissolving crucible 72.

The alloy melted in the dissolution unit 70 may be moved to the nozzle unit 20 in the vacuum chamber 10 via an injection hole 64. For example, if a pressure in the dissolving chamber 60 and a pressure in the vacuum chamber 10 are different from each other, the alloy may move along the injection hole 64 due to the pressure difference. After that, the melted alloy is sprayed to the cooling unit via the nozzle unit 20 in the vacuum chamber 10 to form the rapidly solidified strip 90.

FIG. 2 shows that one dissolution unit 70 is formed in the dissolving chamber 60; however, one or more dissolution units 70 may be provided in the dissolving chamber 60. Otherwise, one or more dissolving chambers 60, each including one or more dissolution units 70, may be provided.

According to the present embodiment, the dissolution unit 70 and the nozzle unit 20 are separately provided, and thus, a capacity of the dissolution unit 70 may be flexibly adjusted according to an amount of the alloy that is to be melted. Also, since the alloy is injected into the nozzle unit 20 in a melted state, a time for receiving the melted alloy in the nozzle unit 20 may be reduced. According to the powder manufacturing apparatus 1a of the present embodiment, the powder alloy may be mass produced, and thereby reducing manufacturing costs and improving productivity.

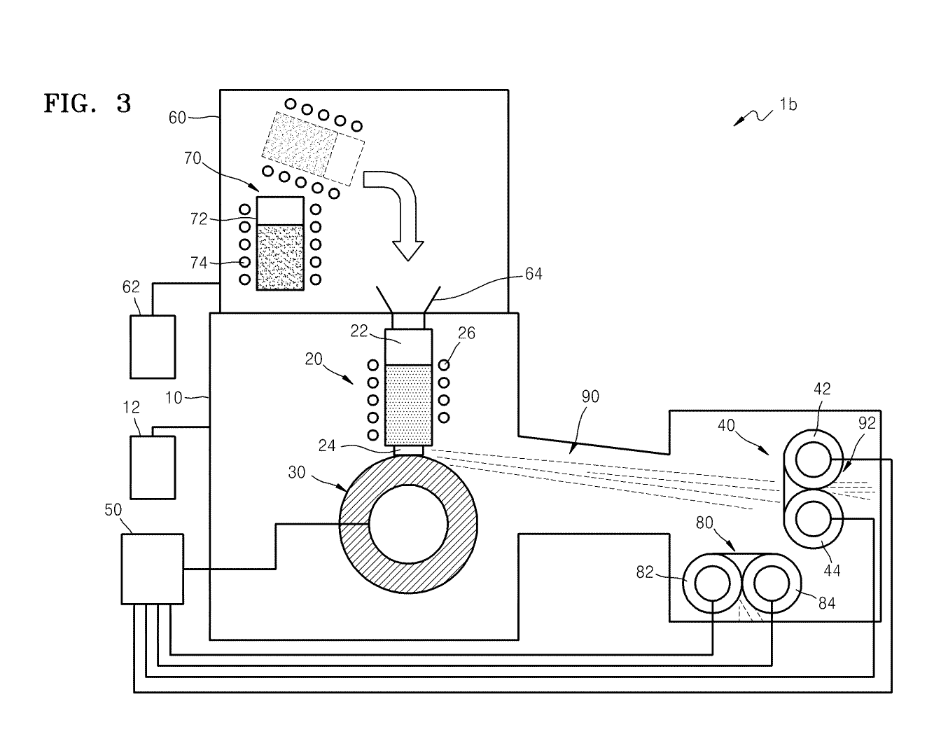

FIG. 3 is a schematic diagram of a powder manufacturing apparatus 1b according to another embodiment of the present invention. The powder manufacturing apparatus 1b of FIG. 3 is the same as the powder manufacturing apparatus 1 shown in FIG. 1, except for further including a plurality of grinding units 40 and 80.

Referring to FIG. 3, a first grinding unit 40 and a second grinding unit 80 are provided in the vacuum chamber 10. The first grinding unit 40 and the second grinding unit 80 may grind the rapidly solidified strips 90 introduced into grinding rollers 42, 44, 82, and 83 thereof, and accordingly, the powder alloy 92 may be manufactured.

In the present embodiment, the first and second grinding units 40 and 80 may be disposed so that rotary shafts thereof may be perpendicular to each other. In this case, while the rapidly solidified strip 90 is introduced into the first grinding unit 40, scattered parts of the rapidly solidified strip 90 may be ground by the second grinding unit 80, and thus, the grinding efficiency of the rapidly solidified strip 90 may be improved.

According to one or more embodiments of the present invention, the first grinding unit 40 and the second grinding unit 80 may be disposed so that the powder alloy 92 that is obtained by passing through the first grinding unit 40 may pass through the second grinding unit 80 again. In this case, the powder alloy 92 may be ground twice in the same vacuum chamber 10, and thus, damage of the powder alloy 92 such as surface oxidation due to the air may be prevented.

In addition, the first and second grinding units 40 and 80 are respectively connected to the cooling tank 50 to improve the cooling effect.

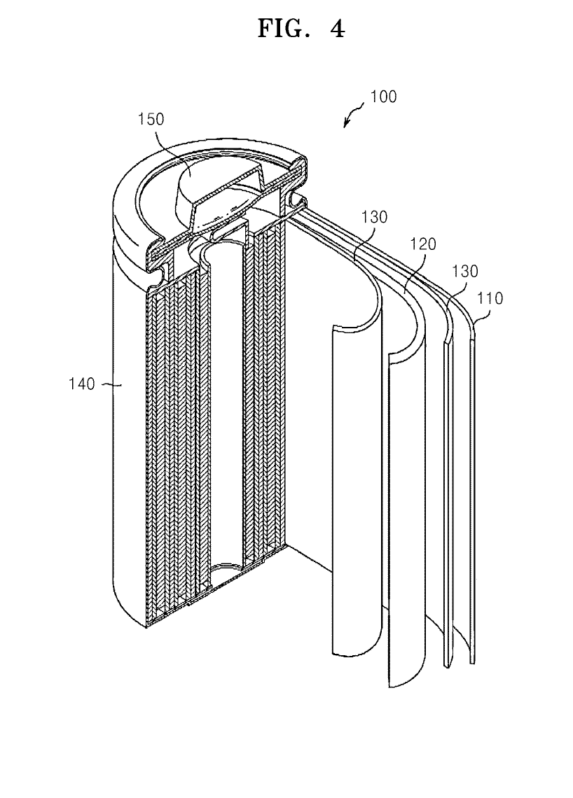

FIG. 4 is a schematic diagram of a secondary battery 100 according to an embodiment of the present invention.

Referring to FIG. 4, a secondary battery 100 may include an anode 110, a cathode 120, a separator 130 disposed between the anode 110 and the cathode 120, a battery container 140, and a sealing member 150. Also, the secondary battery 100 may further include an electrolyte (not shown) with which the anode 110, the cathode 120, and the separator 130 are impregnated. In addition, the anode 110, the cathode 120, and the separator 130 are sequentially stacked and wound as a spiral shape to be accommodated in the battery container 140. The battery container 140 may be sealed by the sealing member 150.

The secondary battery 100 may be a lithium secondary battery using lithium as a medium, and may be classified as a lithium ion battery, a lithium ion polymer battery, and a lithium polymer battery according to a kind of the separator 130 and the electrolyte. In addition, the secondary battery 100 may be formed as a coin type, a button type, a sheet type, a cylinder type, a flat type, and an angular type according to a shape thereof, and may be classified as a bulk type and a thin film type according to a size thereof. The secondary battery 100 shown in FIG. 4 is a cylinder type secondary battery as an example, and one or more embodiments of the present invention are not limited thereto.

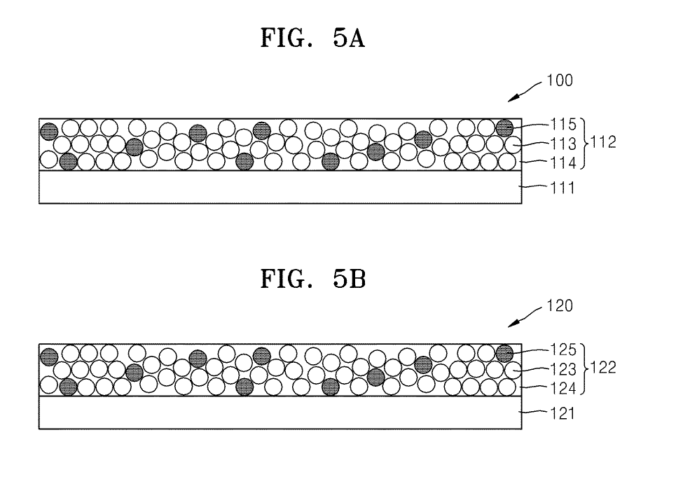

FIG. 5A is a schematic diagram of the anode 110 according to the embodiment of the present invention. The anode 110 shown in FIG. 5A may be the anode 110 included in the secondary battery 100 of FIG. 4.

Referring to FIG. 5A, the anode 110 may include a negative current collector 111, and an anode active material layer 112 located on the negative current collector 111. The anode active material layer 112 may include an anode active material 113, a binder 114, and a conductive material 115.

The negative current collector 111 may include a conductive material, for example, may be a thin conductive foil. For example, the negative current collector 111 may include Cu, gold (Au), nickel (Ni), stainless, titanium (Ti), or an alloy thereof. In addition, the negative current collector 111 may include a conductive polymer, and may be formed by compressing an anode active material.

The anode active material 113 may include a material which lithium ions may be reversibly intercalated into/deintercalated from. According to one or more embodiments of the present invention, the anode active material 113 may include a silicon-metal alloy material, and the silicon-metal alloy material may include silicon particles of a few nm to hundreds of nm dispersed evenly in a silicon-metal matrix. The metal may be a transition metal, or at least one of Al, Cu, Zr, Ni, Ti, Co, Cr, V, Mn, and Fe. In addition, instead of using the silicon, Sn, Al, or Sb may be used. The anode active material 113 may include a powder alloy that is manufactured by using the powder manufacturing apparatus described with reference to FIGS. 1 through 3. Selectively, the anode active material 113 may include alloy fines that are obtained by additionally performing a fine grinding of the alloy particles by a ball-milling method or an air-jet milling method.

The binder 114 may bind the particles of the anode active material 113 together, and bind the anode active material 113 with the negative current collector 111. The binder 114 may be, for example, a polymer, such as polyimide, polyamideimide, polybenzimidazole, polyvinyl alcohol, carboxyl methylcellulose, hydroxypropyl cellulose, polyvinyl chloride, carboxylated polyvinyl chloride, polyvinyl fluoride, ethylene oxide, polyvinyl pyrrolidone, polyurethane, polytetrafluoroethylene, polyvinylidene fluoride, polyethylene, polypropylene, styrene-butadiene, acrylated styrene-butadiene, or epoxy resin.

The conductive material 115 may increase conductivity of the anode 110, and may be a conductive material that does not cause a chemical change in the secondary battery 100. For example, the conductive material 115 may include a carbon-based material, e.g., graphite, carbon black, acetylene black, or carbon fiber; a metal material, e.g., copper, nickel, aluminum, or silver; a conductive polymeric material, e.g., a polyphenylene derivative; or a conductive material including a mixture thereof.

FIG. 5B is a schematic diagram of the cathode 120 included in the secondary battery 100 of FIG. 4.

Referring to FIG. 5B, the cathode 120 includes a positive current collector 121, and a cathode active material layer 122 located on the positive current collector 121. The cathode active material layer 122 includes a cathode active material 123 and a positive binder 124 for binding the cathode active material 123. Also, the cathode active material layer 122 may selectively further include a cathode conductive material 125. Also, although not shown in FIG. 5B, the cathode active material layer 122 may further include an additive such as a filler or a dispersing agent. The cathode 120 may be formed by mixing the cathode active material 123, the cathode binder 124, and/or the cathode conductive material 125 in a solvent to obtain a cathode active material composition, and applying the composition on the positive current collector 121.

The positive current collector 121 may be a thin conductive foil, and may include, for example, a conductive material. The positive current collector 121 may include Al, Ni, or an alloy thereof, for example. Otherwise, the positive current collector 121 may include a polymer including conductive metal, or the positive current collector 121 may be formed by compressing an anode active material.

The cathode active material 123 may be, for example, a cathode active material for a lithium secondary battery, and may include a material which lithium ions may be reversibly intercalated into/deintercalated from. The cathode active material 123 may include a lithium-containing transition metal oxide, a lithium-containing transition metal sulfide, or the like, for example, at least one selected from the group consisting of LiCoO₂, LiNiO₂, LiMnO₂, LiMn₂O₄, Li(NiₐCo_{b}Mn_{c})O₂ (0<a<1, 0<b<1, 0<c<1, a+b+c=1), LiNi_{1-y}Co_{y}O₂, LiCo_{1-y}Mn_{y}O₂, LiNi_{1-y}Mn_{y}O₂ (0≦y<1), Li(NiₐCo_{b}Mn_{c})O₄ (0<a<2, 0<b<2, 0<c<2, a+b+c=2), LiMn_{2-z}Ni_{z}O₄, and LiMn_{2-z}Co_{z}O₄ (0<z<2), LiCoPO₄, and LiFePO₄.

The cathode binder 124 may bind particles of the cathode active material 123 and also binds the cathode active material 123 with the positive current collector 121. The cathode binder 124 may be, for example, a polymer, such as polyimide, polyamideimides, polybenzimidazole, polyvinyl alcohol, carboxylmethyl cellulose, hydroxypropyl cellulose, polyvinyl chloride, carboxylated polyvinyl chloride, polyvinyl fluoride, ethylene oxide, polyvinyl pyrrolidone, polyurethane, polytetrafluoroethylene, polyvinylidene fluoride, polyethylene, polypropylene, styrene-butadiene, acrylated styrene-butadiene, or epoxy resin.

The cathode conductive material 125 may increase conductivity of the cathode 120, and may be a conductive material that does not cause a chemical change in the secondary battery 100. For example, the cathode conductive material 125 may include a carbon-based material, e.g., graphite, carbon black, acetylene black, or carbon fiber; a metal material, e.g., copper, nickel, aluminum, or silver; a conductive polymeric material, e.g., a polyphenylene derivative; or a conductive material including a mixture thereof.

Referring back to FIG. 4, the separator 130 may be a porous material, and may be a single film or a multi-layered film including two or more layers. The separator 130 may include a polymeric material, e.g., at least one selected from the group consisting of a polyethylene-based polymer, a polypropylene-based material, a polyvinylidene fluoride-based polymer, and a polyolefin-based polymer.

The electrolyte with which the anode 110, the cathode 120, and the separator 130 are impregnated may include a non-aqueous solvent and electrolyte salt. The type of the non-aqueous solvent is not limited if it may be used for a general non-aqueous electrolyte solution. Examples of the non-aqueous solvent may include a carbonated solvent, an ester-based solvent, an ether-based solvent, a ketone-based solvent, an alcohol-based solvent, or a nonprontonic solvent. A non-aqueous solvent or a mixture of two or more non-aqueous solvents may be used. When the mixture of two or more non-aqueous solvents is used, a mixing ratio of the two or more non-aqueous solvents may be appropriately adjusted according to a desired performance of a battery.

The type of the electrolyte salt is not limited if it may be used for a general non-aqueous electrolytic solution. For example, the electrolyte salt may be salt having an A⁺B⁻ structure. Here, ‘A⁺’ may denote alkaline metal positive ions, e.g., as Li⁺, Na⁺, or K⁺, or a combination thereof. ‘B⁻’ may denote negative ions, e.g., PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, or C(CF₂SO₂)₃⁻, or a combination thereof. For example, the electrolyte salt may be lithium-based salt, e.g., at least one selected from the group consisting of LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), LiCl, LiI, and LiB(C₂O₄)₂. Here, ‘x’ and ‘y’ each denote a natural number.

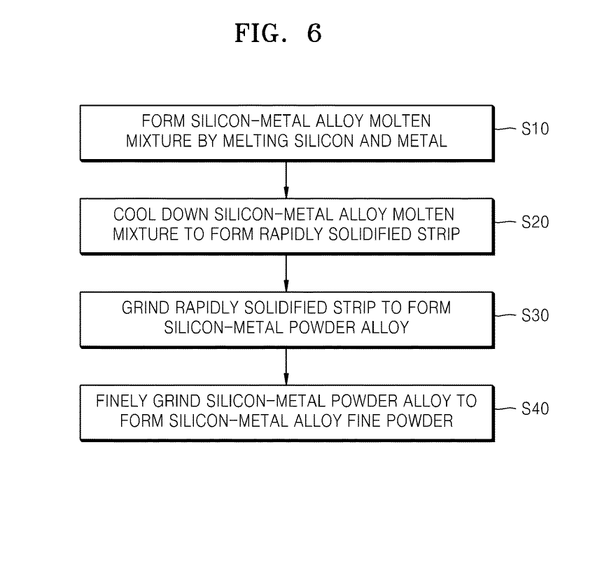

FIG. 6 is a flowchart illustrating a method of fabricating an anode, according to an embodiment of the present invention.

Referring to FIG. 6, silicon and a metal material are melted together to form a molten mixture (operation S10). The silicon and the metal material may be melted together, for example, by generating induced heat of the silicon or the metal material through high-frequency induction using a high-frequency induction furnace. Otherwise, the molten mixture may be generated by using an arc melting process. For example, the silicon-metal powder alloy may be silicon-nickel-titanium powder alloy; however, one or more embodiments of the present invention are not limited thereto. That is, any kind of material which lithium ions intercalated into/deintercalated from to act as an anode material may be used. For example, when the powder manufacturing apparatus described with reference to FIGS. 1 through 3 is used, silicon and metal are inserted in the nozzle unit of the vacuum chamber and heat is applied to the silicon and metal via the heating unit to form the silicon-metal alloy molten mixture. Otherwise, the silicon-metal alloy molten mixture may be formed in a dissolving unit of the dissolution chamber.

After that, the silicon-metal alloy molten mixture is cooled down to form a rapidly solidified strip (operation S20). In the embodiments of the present invention, the cooling operation may be performed by using the powder manufacturing apparatus described with reference to FIGS. 1 through 3. For example, the molten mixture sprayed from the nozzle unit is rapidly cooled when contacting the roll of the cooling unit to form the rapidly solidified strip.

The rapidly solidified strip is ground to generate silicon-metal powder alloy (operation S30). In the embodiments of the present invention, the grinding process may be performed by using the powder manufacturing apparatus described with reference to FIGS. 1 through 3. For example, the rapidly solidified strip that is cooled down by the cooling unit is captured by the grinding unit, and one or more grinding units may grind the rapidly solidified strip to form the silicon powder alloy. The grinding process may be performed in the chamber where the cooling process is performed, and the chamber is maintained at the vacuum state so that the oxidation on the rapidly solidified strip or the silicon-metal powder alloy due to the air. In the embodiments of the present invention, the ground silicon-metal powder alloy has a diameter ranging from about 1 to 1000 μm. For example, the ground silicon-metal powder alloy has a diameter of about 50 to about 500 μm. However, the diameter of the powder alloy is not limited to the above examples, and may vary depending on a size of the rapidly solidified strip and a rotating speed of the grinding unit. For example, in a grain size distribution of the powder alloy, when a powder diameter at which a ratio of powder particles accumulated from the smallest one corresponds to 10% is defined as D0.1 and a powder diameter at which a ratio of the accumulated powder particles corresponds to 90% is defined as D0.9, a value of D0.1 of the powder alloy may be 1 μm or greater and a value of D0.9 of the powder alloy may be 1000 μm or less.

Then, the silicon-metal powder alloy is finely ground to generate silicon-metal alloy fine powder (operation S40). In the embodiments of the present invention, the fine grinding process may be performed by a ball milling process or an air-jet milling process. In an example of using the ball milling process, the silicon-metal powder alloy and a zirconia ball are inserted in a milling container, and then the ball milling process may be performed for about 10 to 100 hours at a speed of about 100 to 500 rpm. In another embodiment, the fine grinding process may be performed by using the powder manufacturing apparatus described with reference to FIGS. 1 to 3. In this case, in the powder manufacturing apparatus including one or more grinding units, the silicon-metal powder alloy that is ground by a first grinding unit is captured by a second grinding unit and finely ground, and then, the silicon-metal alloy fine powder may be manufactured. In the embodiments of the present invention, the silicon-metal alloy fine powder has a diameter of 0.1 to 100 μm. However, the diameter of the fine powder is not limited thereto, and the diameter of the fine powder may vary depending on the diameter of the silicon-metal powder alloy used in the fine grinding, a usage amount of the zirconia ball, a rotating speed of the ball milling, and the rotation speed of the grinding unit. For example, a value of D0.1 of the silicon-metal alloy fine powder may be 0.1 μm or greater, and a value of D0.9 may be 100 μm or less.

After that, the silicon-metal alloy fine powder is mixed with a conductive material of a predetermined concentration and a binder to form slurry, and the slurry is applied and dried on a negative current collector, thereby fabricating the anode shown in FIG. 5A.

### EXPERIMENTAL EXAMPLES

### 1. Preparing Experimental Examples

Anode active materials prepared by experimental examples 1 through 9 were manufactured by differentiating rotation speeds of the roll of the cooling unit and rotation speeds of the grinding rollers in the grinding unit as shown in following Table 1. In experimental examples 1 through 9, the powder manufacturing apparatus of FIG. 1 was used, the rotation speed of the roll in the cooling unit was set as 1600 rpm, 1800 rpm, and 2000 rpm, and the rotation speed of the grinding roller in the grinding unit was set as 1600 rpm, 1800 rpm, and 2000 rpm. As a comparative example, a rapidly solidified strip was fabricated by using a cooling roll having a rotation speed of 1800 rpm without using the grinding unit.

### 2. Particle-Size Distribution of the Powder Alloy

The particle-size distribution of the powder alloy was measured by using MASTERSIZER 2000 of Malvern, Inc. In a graph showing a distribution of the number of particles with respect to the powder diameter, a powder diameter at a point where the accumulated number of powder particles corresponds to 10% of the number of entire particles is determined as D0.1. Also, powder diameters at points where the accumulated number of the powder particles corresponds to 50% and 90% of the number of entire particles are respectively defined as D0.5 and D0.9. That is, D0.5 denotes a median value in the particle-size distribution, and D0.1 and D0.9 respectively denote particles sizes corresponding to 10% from the lowest and 10% from the highest. Table 1 shows particles sizes D0.1, D0.5, and D0.9 of the powder alloy obtained through the experimental examples 1 through 9.

TABLE 1

| | Rotation | Rotation | | | | |
|---|---|---|---|---|---|---|
| | speed of | speed of | Particle | Particle | Particle | |
| | cooling | grinding | size | size | size | D0.9- |
| | roll | unit | (D 0.1) | (D 0.5) | (D 0.9) | D0.1 |
| | [rpm] | [rpm] | [μm] | [μm] | [μm] | [μm] |
| Comparative | 1800 | — | — | — | — | — |
| example | | | | | | |
| Experimental | 1600 | 1600 | 47.6 | 147.4 | 455.4 | 407.8 |
| example 1 | | | | | | |
| Experimental | 1600 | 1800 | 45.2 | 134.5 | 389.2 | 344 |
| example 2 | | | | | | |
| Experimental | 1600 | 2000 | 43.2 | 123.7 | 332.8 | 289.6 |
| example 3 | | | | | | |
| Experimental | 1800 | 1600 | 42.7 | 116.8 | 289.4 | 246.7 |
| example 4 | | | | | | |
| Experimental | 1800 | 1800 | 40.6 | 100.1 | 234.5 | 193.9 |
| example 5 | | | | | | |
| Experimental | 1800 | 2000 | 38.1 | 73.8 | 178.3 | 140.2 |
| example 6 | | | | | | |
| Experimental | 2000 | 1600 | 26.1 | 51.2 | 93.1 | 67 |
| example 7 | | | | | | |
| Experimental | 2000 | 1800 | 25.8 | 50.9 | 92.1 | 66.3 |
| example 8 | | | | | | |
| Experimental | 2000 | 2000 | 25.4 | 50.2 | 90.5 | 65.1 |
| example 9 | | | | | | |

Referring to Table 1, when the rotation speed of the cooling roll increases, a value of D0.5 is increased, and a value of D0.9-D0.1 is reduced. That is, if the rotation speed of the cooling roll is increased, a size of the rapidly solidified strip is reduced, and the ground alloy powder may have fine and uniform distribution. Also, if the rotation speed of the grinding roll is increased, the value of D0.5 is reduced, and the value of D0.9-D0.1 is reduced. That is, when the rotation speed of the grinding roll is increased, a grinding performance of grinding the rapidly solidified strip into the powder alloy is improved, and the powder alloy may have fine and uniform distribution.

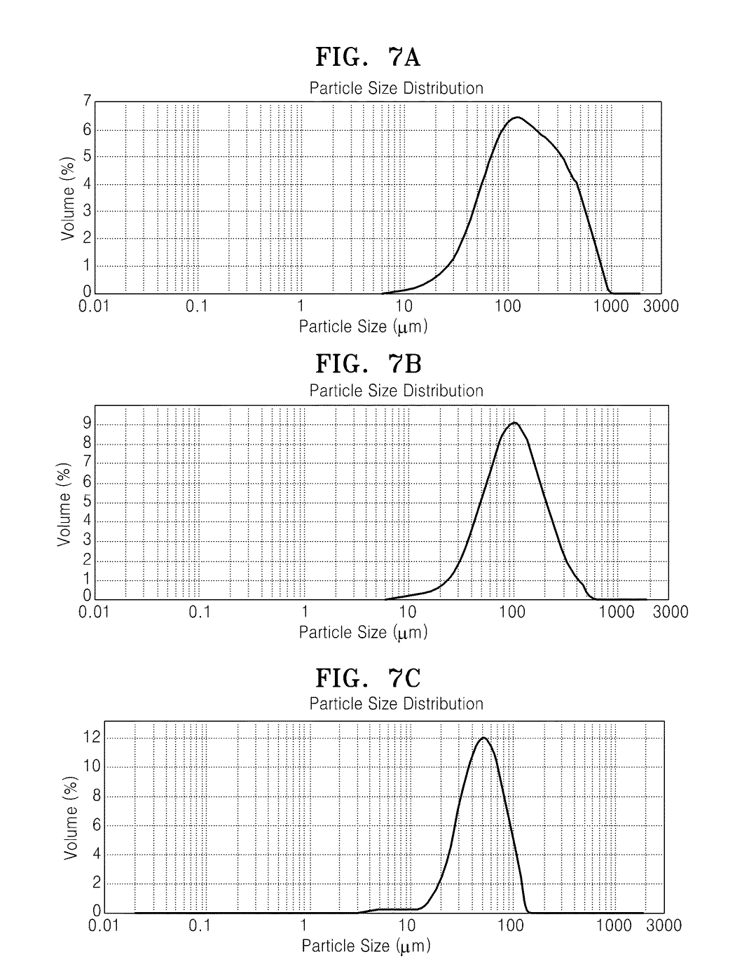

FIGS. 7A through 7C are graphs showing particle-size distributions of the silicon-metal powder alloy according to embodiments of the present invention. FIGS. 7A, 7B, and 7C are graphs respectively showing the particle-size distributions of the power alloys that were manufactured according to the experimental examples 1, 5, and 9, respectively.

Referring to FIGS. 7A through 7C, the powder alloys according to the experimental examples 1, 5, and 9 respectively have D0.5 values of 147.4 μm, 100.1 μm, and 50.2 μm. Also, with respect to the dispersity of the distribution, the powder alloys of the experimental examples 1, 5, and 9 respectively have values of D0.9-D0.1, that is, 407.8 μm, 193.9 μm, and 65.1 μm. Therefore, it is identified that when the rotation speeds of the cooling roll and the grinding roll are increased, the powder alloy may have fine and uniform particle distribution.

### 3. Particle-Size Distribution of Alloy Fine Powder

The powder alloys according to the experimental examples 1 through 9 shown in Table 1 were additionally ground to manufacture silicon-metal alloy fine powder, and particle-size distribution of the silicon-metal alloy fine powder is shown in Table 2.

The above fine grinding process was performed by using a ball milling process. The power alloy and a zirconia ball having a diameter of 5 mm were inserted in a milling container having a capacity of 500 ml, and the ball milling process was performed for 48 hours at a speed of 200 rpm to manufacture the silicon-metal alloy fine powders according to the experimental examples 1 through 9. According to a comparative example, a rapidly solidified strip and a zirconia ball were inserted in the milling container, and the ball milling process was performed.

TABLE 2

| | Particle | Particle | Particle | | | |
|---|---|---|---|---|---|---|
| | size | size | size | D0.9- | Grain | |
| | (D 0.1) | (D 0.5) | (D 0.9) | D0.1 | size | Lattice |
| | [μm] | [μm] | [μm] | [μm] | [nm] | strain |
| Comparative | 0.6 | 2.9 | 19.7 | 19.1 | 43.9 | 0.321 |
| example | | | | | | |
| Experimental | 0.7 | 4.0 | 18.1 | 17.4 | 44.1 | 0.319 |
| example 1 | | | | | | |
| Experimental | 0.7 | 3.9 | 17.9 | 17.2 | 43.3 | 0.328 |
| example 2 | | | | | | |
| Experimental | 0.8 | 3.8 | 15.6 | 14.8 | 42.8 | 0.331 |
| example 3 | | | | | | |
| Experimental | 0.8 | 3.6 | 13.6 | 12.8 | 41.9 | 0.339 |
| example 4 | | | | | | |
| Experimental | 0.8 | 3.6 | 12.0 | 11.2 | 41.2 | 0.341 |
| example 5 | | | | | | |
| Experimental | 0.8 | 3.4 | 12.4 | 11.6 | 40.6 | 0.350 |
| example 6 | | | | | | |
| Experimental | 0.7 | 3.3 | 12.2 | 11.5 | 40.1 | 0.354 |
| example 7 | | | | | | |
| Experimental | 0.8 | 3.1 | 12.1 | 11.3 | 39.7 | 0.359 |
| example 8 | | | | | | |
| Experimental | 0.8 | 3.0 | 10.6 | 9.8 | 38.6 | 0.365 |
| example 9 | | | | | | |

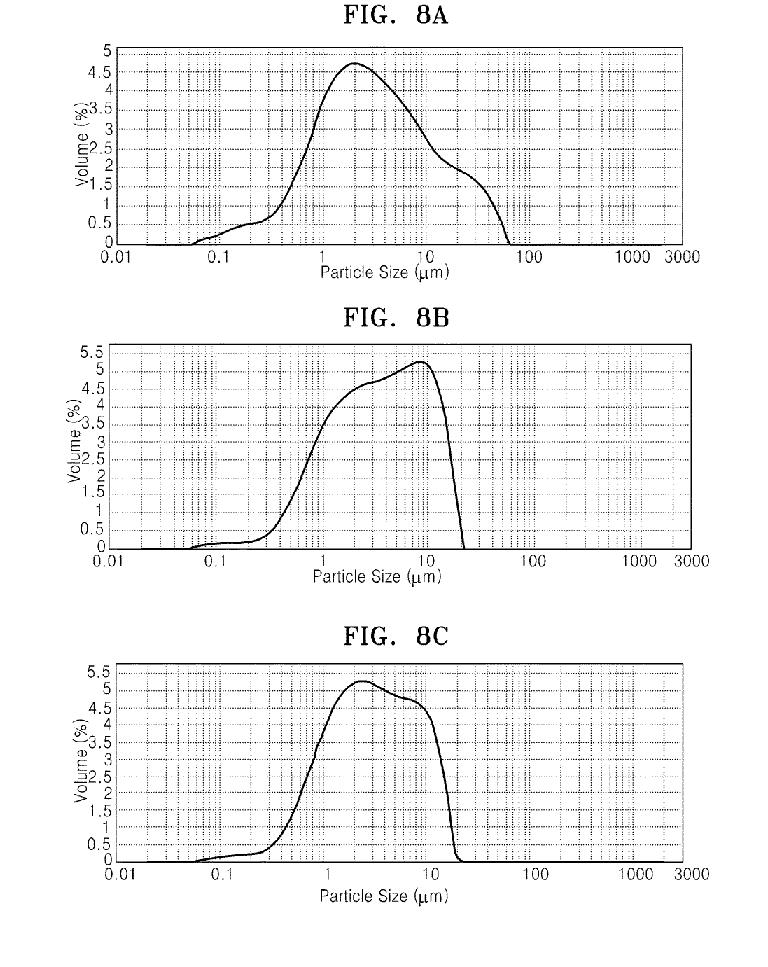

FIGS. 8A through 8C are graphs showing particle-size distributions of silicon-metal alloy fine powders according to the embodiments of the present invention. FIGS. 8A, 8B, and 8C are graphs respectively showing the particle-size distributions of the alloy fine powders that are obtained by finely grinding the powder alloys manufactured according to the comparative example, the experimental example 5, and the experimental example 9.

Referring to FIGS. 8A through 8C, the alloy fine powders according to the comparative example, the experimental example 5, and the experimental example 9 respectively have D0.5 values of 2.9 μm, 3.6 μm, and 3.0 μm. In addition, with respect to a dispersity in the distribution, the alloy fine powders according to the comparative example, the experimental example 5, and the experimental example 9 respectively have D0.9-D0.1 values of 19.1 μm, 11.2 μm, and 9.8 μm. In particular, the comparative example has a wide distribution of particles, which denotes that a ratio between a fine particle and a large particle from among the entire fine particles is relatively large, when being compared with the experimental examples. According to the experimental examples 1 and 9, the alloy fine powders have uniform distribution, when compared with the comparative example. In addition, when the power alloy before performing the fine grinding process has the fine and uniform distribution, the fine and uniform particle distribution may be obtained after performing the fine grinding process by using the ball milling process.

### 4. Observation of Fine Structures of Power Alloy and Alloy Fine Powder

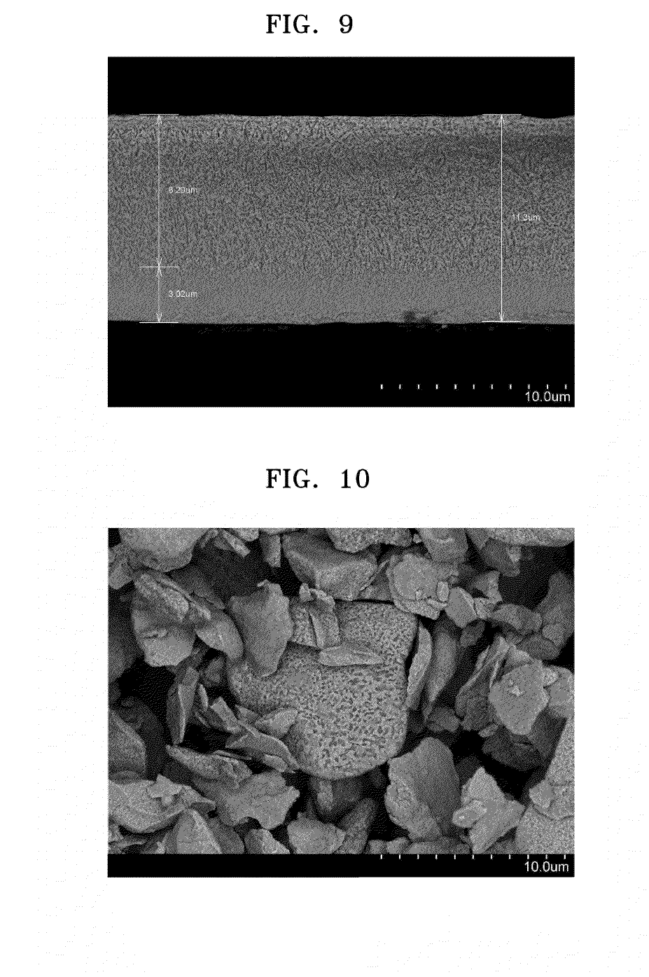

FIG. 9 is an image showing a fine structure of a rapidly solidified strip, according to a comparative example. As shown in Table 1, the rapidly solidified strip was obtained in a cooled state by the cooling roll having a rotation speed of 1800 rpm, and the rapidly solidified strip had a ribbon shape having a thickness of about 11.3 μm. The rapidly solidified strip has a fine structure, in which silicon single phases of a few to tens of nm are evenly distributed in a silicon-metal alloy matrix. In FIG. 9, black fine particles denote the silicon single phases.

A lower portion of the rapidly solidified strip (3.02 μm from a bottom surface) has a fine structure that is different from that of remaining part in the rapidly solidified strip. Since the lower portion contacting the cooling roll is cooled down at the fastest speed, the silicon single phases having fine sizes that are unable to be observed are precipitated.

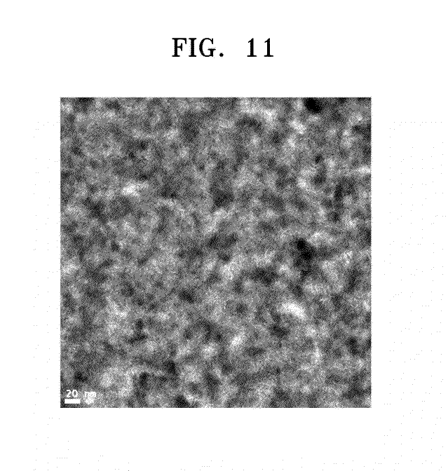

FIGS. 10 and 11 are images showing fine structures of silicon-metal alloy fine powders according to the embodiments of the present invention.

FIG. 10 is a scanning electron microscopy (SEM) image of the powder alloy according to the experimental example 1, that is, the power alloy ground by the cooling roll and the grinding roll. The powder alloy has a diameter of hundreds of nm to 10 μm, and black silicon single phases are uniformly distributed in the power alloy.

FIG. 11 is a transmission electron microscopy (TEM) image of an alloy fine powder according to the experimental example 9, that is, the alloy fine powder obtained by finely grinding the power alloy that is ground by the grinding roll by using the ball milling process. The alloy fine powder has a fine structure, in which the silicon single phases are uniformly distributed in a silicon-metal alloy matrix, and the silicon single phases may have a diameter of a few nm to tens of nm.

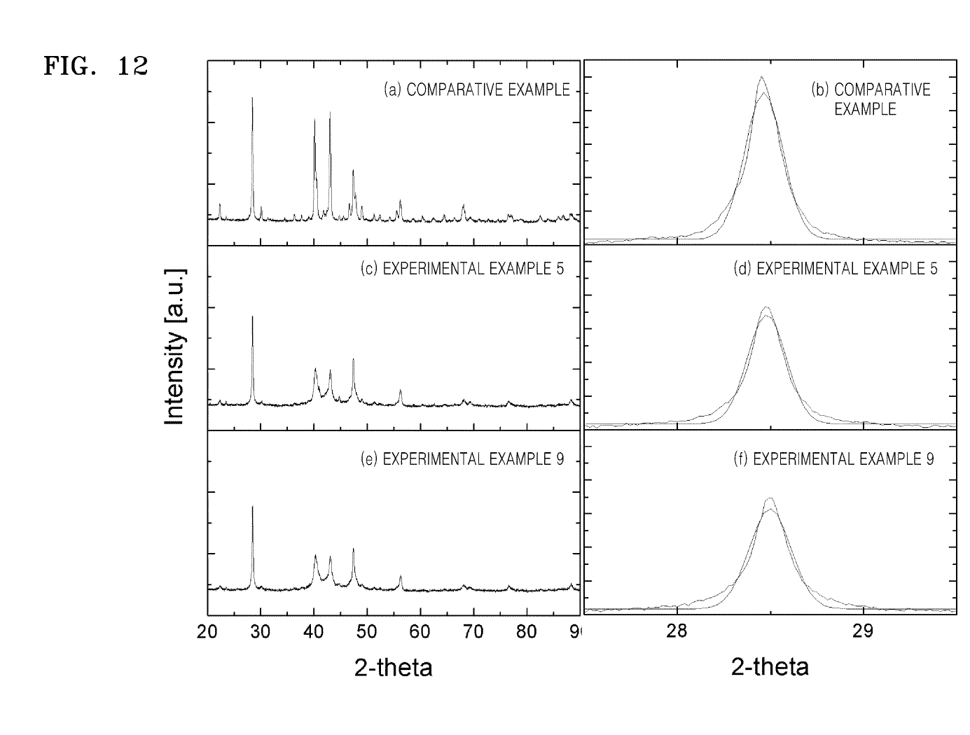

FIG. 12 is graphs showing X-ray diffraction patterns of the alloy fine powders according to the embodiments of the present invention. In FIG. 12, the X-ray diffraction patterns of the alloy fine powders according to the comparative example ((a) and (b)), the experimental example 5 ((c) and (d)), and the experimental example 9 ((e) and (f)) are shown. In (b), (d), and (f) of FIG. 12, diffraction patterns of the silicon single phases having peaks between 28° and 29° are expanded. Table 2 shows average grain sizes (nm) of the silicon single phases and lattice strain values calculated based on the X-ray diffraction patterns of FIG. 12. Referring to FIG. 12 and Table 2, the experimental examples of the present invention have an average grain size of about 38.6 nm to about 44.1 nm, and have a lattice strain value of about 0.319 to about 0.365.

### 5. Evaluation of Electrochemical Characteristics

A secondary battery half-cell was manufactured in order to evaluate electrochemical characteristics of the alloy powder according to the embodiments of the present invention. A coin cell was manufactured by using metal lithium as a reference electrode, the alloy fine powders according to the experimental examples 1 and 9, and the comparative example as measurement electrodes, and the separator formed of a polyethylene film.

An initial discharge capacity, an initial efficiency, and a capacity retention rate of the half-cell were measured. Here, first and second charging/discharging operations were performed at a current density of 0.1 C and 0.2 C, and third through fiftieth charging/discharging operations were performed at a current density of 1.0 C.

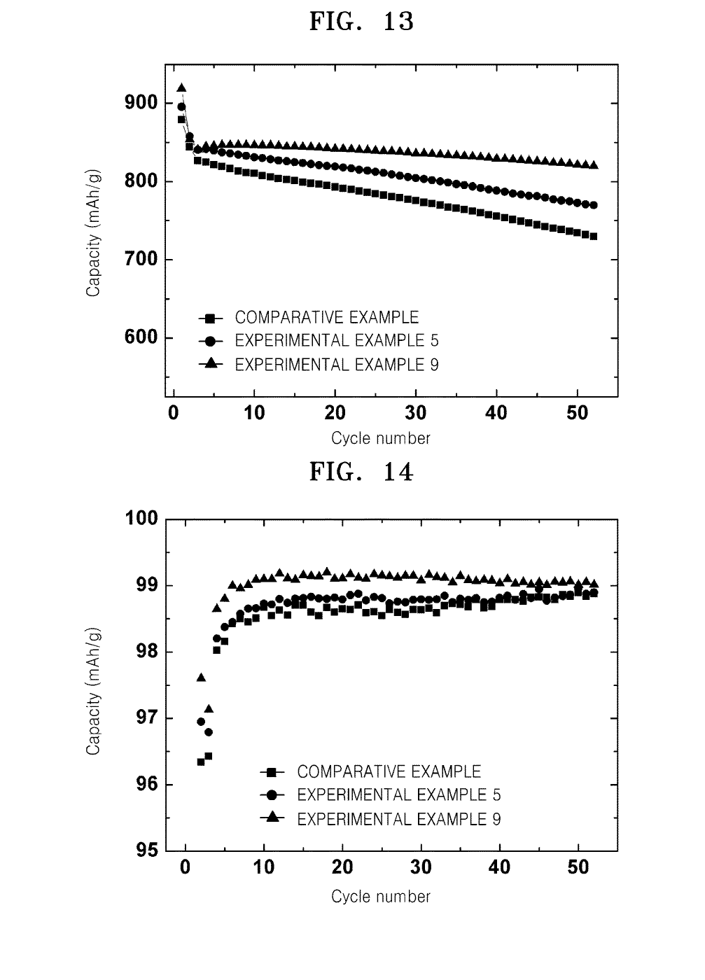

FIGS. 13 and 14 are graphs showing cyclic characteristics of the anode according to the embodiments of the present invention. FIG. 13 shows discharge capacities of anodes using the alloy fine powders according to the comparative example, the experimental example 5, and the experimental example 9 to 50 cycles, and FIG. 14 shows charging/discharging efficiencies to the 50 cycles.

Referring to FIGS. 13 and 14, the anode using the silicon-metal alloy fine powder according to the experimental examples of the present invention has superior charging/discharging characteristics and superior discharge capacity to those of the comparative example. In particular, the anode according to the experimental example 9 shows a high capacity retention rate of 97.5% and a high charging/discharging efficiency (a ratio of a discharge capacity with respect to a charge capacity) after 52 charging/discharging cycles.

In general, when silicon (Si), tin (Sn), antimony (Sb), aluminum (Al), or the like are electrochemically plated with lithium, the volume of the resultant structure increases or decreases during a charge/discharge process. Such a volume change deteriorates cycle characteristics of an electrode employing silicon (Si), tin (Sn), antimony (Sb), aluminum (Al), or the like as an anode active material. Also, such a volume change causes cracks in a surface of the electrode active material. When cracks occur repeatedly in the surface of the electrode active material, fine particles may be formed in the surface of the electrode, thereby deteriorating cyclic characteristics. However, according to the alloy fine powder of the embodiments of the present invention, the silicon single phases of fine sizes are evenly distributed in the silicon-metal alloy matrix, and thus, the volume change of the silicon single phases may be buffered by the matrix, and thereby reducing a stress caused by the volume change. Therefore, the anode active material according to the embodiments of the present invention may have an excellent cyclic characteristic.

TABLE 3

| | Comparative | Experimental | Experimental |
|---|---|---|---|
| | example | example 5 | example 9 |
| First charging capacity | 1081 | 1094 | 1075 |
| [mAh/g] | | | |
| First discharging capacity | 870 | 857 | 847 |
| [mAh/g] | | | |
| First charging/discharging | 80.6 | 81.9 | 84.7 |
| efficiency [%] | | | |
| Third discharging capacity | 824 | 841 | 839 |
| [mAh/g] | | | |
| 52nd discharging capacity | 728 | 768 | 818 |
| [mAh/g] | | | |
| Capacity retention rate [%] | 87.9 | 91.3 | 97.5 |
| (52nd/3rd) | | | |
| 52nd charging/discharging | 98.9 | 98.7 | 99.5 |
| efficiency [%] | | | |

According to the powder manufacturing apparatus of the present invention, the nozzle unit, the cooling unit, and the grinding unit are included in a first chamber so as to effectively adjust a particle-size distribution of the powder alloy and manufacture silicon-metal powder alloy having excellent lifespan characteristic. A secondary battery including the anode active material that is formed by using the powder alloy has an extended cycle-life.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. An apparatus for manufacturing a powder alloy used as an anode active material of a secondary battery, the apparatus comprising:
a nozzle unit for melting and spraying an alloy;
a cooling unit for cooling down the alloy sprayed from the nozzle unit;
a grinding unit for grinding the alloy cooled by the cooling unit; and
a first chamber accommodating the nozzle unit, the cooling unit, and the grinding unit, and maintained to be a vacuum state.

2. The apparatus of claim 1, wherein the nozzle unit comprises:
an accommodation unit for accommodating the alloy;
a heating unit for melting the alloy; and
a nozzle hole for spraying the alloy.

3. The apparatus of claim 2, wherein the accommodation unit is formed of one of graphite, an aluminum oxide (Al₂O₃), a zirconium oxide (ZrO₂), and a boron nitride (BN).

4. The apparatus of claim 1, wherein the cooling unit is formed as a roll, and rapidly cools the alloy sprayed from the nozzle unit while rotating in order to form a rapidly solidified strip.

5. The apparatus of claim 4, wherein the rapidly solidified strip is continuously extended to the grinding unit within the first chamber.

6. The apparatus of claim 1, wherein the grinding unit comprises a roll, and further cools the alloy that is cooled by the cooling unit and grinds the alloy while rotating the roll.

7. The apparatus of claim 6, wherein the grinding unit comprises one or more disk plates.

8. The apparatus of claim 6, wherein a rotary shaft of the grinding unit is perpendicular to a rotary shaft of the cooling unit.

9. The apparatus of claim 1, wherein the grinding unit comprises:
a first grinding unit for firstly cooling and grinding the alloy cooled by the cooling unit; and
a second grinding unit for secondly cooling and grinding the alloy ground by the first grinding unit.

10. The apparatus of claim 1, further comprising:
a dissolution unit for melting the alloy; and
a second chamber accommodating the dissolution unit and maintained to be a vacuum state,
wherein the alloy melted in the dissolution unit is configured to be moved into the nozzle unit.

11. The apparatus of claim 10, wherein the dissolution unit comprises:
a dissolving crucible for accommodating the alloy; and
a heating unit for melting the alloy.

12. An anode active material for a secondary battery, the anode active material comprising a powder alloy manufactured by the apparatus for manufacturing a powder alloy according to claim 1, wherein the powder alloy includes silicon single phases, each having a grain size of about 100 nm or less, are evenly distributed in a matrix of a silicon-metal alloy.

13. The anode active material of claim 12, wherein in a particle-size distribution of the powder alloy, when a powder diameter at a point where the number of powder particles accumulated from the smallest one corresponds to 10% of the number of entire particles is defined as D0.1, and a powder diameter at a point where the number of powder particles accumulated from the smallest one corresponds to 90% of the number of entire particles is defined as D0.9, a value of D0.1 of the powder alloy is 1 μm or greater and a value of D0.9 is 1000 μm or less.

14. The anode active material of claim 12, wherein the powder alloy is included in the anode active material in a state of alloy fine powders ground finely by a ball milling process, and in a particle-size distribution of the powder alloy, when a powder diameter at a point where the number of powder particles accumulated from the smallest one corresponds to 10% of the number of entire particles is defined as D0.1, and a powder diameter at a point where the number of powder particles accumulated from the smallest one corresponds to 90% of the number of entire particles is defined as D0.9, a value of D0.1 of the alloy fine powder is 0.1 μm or greater and a value of D0.9 is 100 μm or less.
